(19) United States
(12) Patent Application Publication
(10) Pub. No.: US 2006/0286390 A1
(43) Pub. Date: Dec. 21, 2006

(54) SILICONE RUBBER COATING COMPOSITION AND AIRBAG

(75) Inventors: Atsushi YAGINUMA, Annaka-shi (JP); Takeshi Miyao, Annaka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/423,560

(22) Filed: Jun. 12, 2006

(30) Foreign Application Priority Data
Jun. 15, 2005 (JP) 2005-174566

(51) Int. Cl. D06M 15/643; B32B 9/04; C08L 83/04

(52) U.S. Cl. 428/447; 524/492; 528/15; 528/31; 528/32

(57) ABSTRACT

A silicone rubber coating composition comprising (A) a diorganopolysiloxane containing at least two alkenyl groups, (B) an organopolysiloxane resin, (C) finely divided silica, (D) an organohydrogenpolysiloxane containing at least two SiH groups, (E) an addition reaction catalyst, (F) an organosilicon compound containing a tackifying functional group, and (G) an organic titanium or zirconium compound is coated onto a base fabric to form a coated fabric, from which airbags are manufactured. The composition has a sufficient adhesion to withstand high temperature and abrupt elongation upon inflation of an airbag even after long-term storage under hot humid conditions, and can form a uniform thin-film.

### CROSS-REFERENCE TO RELATED APPLICATION

This non-provisional application claims priority under 35 U.S.C. §119(a) on Patent Application No. 2005-174566 filed in Japan on Jun. 15, 2005, the entire contents of which are hereby incorporated by reference.

### TECHNICAL FIELD

This invention relates to silicone rubber coating compositions for airbags, and airbags using the same to be installed on transportation vehicles. More particularly, it relates to a silicone rubber coating composition which has a sufficient adhesion to withstand high temperature and abrupt elongation upon inflation of an airbag even after long-term storage under hot humid conditions, and can form a uniform thin-film, and an airbag having a cured film of the composition.

### BACKGROUND ART

Silicone rubber is widely used in a variety of applications due to excellent properties including heat resistance, freeze resistance, electrical insulation, flame retardance and compression set. Recently, airbags of silicone rubber-coated nylon fabric were marketed and are now used in the industry as a replacement of prior chloroprene rubber-coated bags.

The newest type airbag system is a side curtain airbag which is designed for mitigating shocks to the passenger upon side collision or for preventing the passenger from being thrown out upon vehicle overturn. When inflated, the side curtain airbag must keep a gas pressure (or internal pressure) generated by the explosion of an inflating agent for at least a certain time. Demanded is a coating agent having better adhesion than prior art coating agents. Since the airbag stays within the vehicle for a long period of time, long-term durability under hot humid conditions is one important factor.

For airbags, several silicone rubber coating compositions are known. JP-A 5-25435 and JP-A 5-98579 corresponding to U.S. Pat. No. 5,254,621 propose coating compositions comprising an organosilicon compound having an epoxy group and an organosilicon compound having an isocyanate group as a tackifier, respectively. When airbags using these coating compositions are stored under hot humid conditions for a long period of time, the adhesion lowers, undesirably allowing for peeling.

Since it is desired to reduce the amount of silicone coating composition coated to nylon fabric for the purpose of weight reduction, an ability to form a uniform thin-film on the fabric becomes an important factor as well.

### SUMMARY OF THE INVENTION

An object of the present invention is to provide a silicone rubber coating composition for airbags which has a sufficient adhesion to withstand high temperature and abrupt elongation upon inflation of an airbag even after long-term storage under hot humid conditions, and can form a uniform thin-film, and an airbag having a cured film of the composition.

The inventor has discovered that the problem of long-term durability under hot humid conditions is overcome by adding and compounding an organic titanium or zirconium compound to a silicone rubber coating composition comprising a diorganopolysiloxane containing at least two alkenyl groups on the molecule, an organopolysiloxane resin, an organohydrogenpolysiloxane containing at least two silicon-bonded hydrogen atoms on the molecule, an addition reaction catalyst, and an organosilicon compound containing a tackifying functional group. It has also been discovered that when the amount of reinforcing organopolysiloxane resin compounded is minimized and finely divided silica is added and compounded, the resulting composition is provided with satisfactory bond strength and can form a uniform thin-film cured coating.

Accordingly, the present invention provides a silicone rubber coating composition for airbags, comprising

(A) 100 parts by weight of a diorganopolysiloxane containing at least two alkenyl groups on the molecule,

(B) 0 to 5 parts by weight of an organopolysiloxane resin,

(C) 0.1 to 50 parts by weight of finely divided silica having a specific surface area of at least 50 m²/g,

(D) an organohydrogenpolysiloxane containing at least two silicon-bonded hydrogen atoms on the molecule, in such an amount that 0.5 to 20 moles of silicon-bonded hydrogen atoms are available per mole of total silicon-bonded alkenyl groups in components (A) and (B),

(E) a catalytic amount of an addition reaction catalyst,

(F) 0.1 to 10 parts by weight of an organosilicon compound containing a tackifying functional group, and

(G) 0.01 to 10 parts by weight of an organotitanium compound and/or an organozirconium compound.

Also contemplated herein is an airbag comprising a base fabric and a cured film formed thereon from the silicone rubber coating composition.

### BENEFITS OF THE INVENTION

The silicone rubber coating composition of the invention, when coated to a base fabric, forms a uniform thin-film cured coating. Even after the airbag fabricated using the cured thin-film coated fabric is stored under hot humid conditions over a long period of time, the coating keeps a sufficient adhesion to the base fabric to withstand high temperature and abrupt elongation upon inflation of the airbag.

### DESCRIPTION OF THE PREFERRED EMBODIMENTS

Briefly stated, the silicone rubber coating composition of the invention comprises (A) a diorganopolysiloxane containing at least two alkenyl groups on the molecule, (B) an organopolysiloxane resin, (C) finely divided silica, (D) an organohydrogenpolysiloxane containing at least two silicon-bonded hydrogen atoms on the molecule, (E) an addition reaction catalyst, (F) an organosilicon compound containing a tackifying functional group, and (G) an organotitanium compound and/or an organozirconium compound, which are described in detail below.

The diorganopolysiloxane (A), which is a base polymer of the inventive composition, contains on the average at least two silicon atom-bonded alkenyl groups on the molecule. Suitable alkenyl groups are generally alkenyl groups of about 2 to 8 carbon atoms, preferably about 2 to 4 carbon atoms, such as vinyl, allyl, butenyl, pentenyl, hexenyl and heptenyl, with vinyl being most preferred. The alkenyl groups may be bonded to silicon atoms, for example, at ends and/or side chains of the molecular chain.

In addition to the alkenyl groups, the diorganopolysiloxane (A) contains silicon atom-bonded organic groups. Suitable organic groups include unsubstituted or halo-substituted monovalent hydrocarbon groups of about 1 to 12 carbon atoms, preferably about 1 to 10 carbon atoms, for example, alkyl groups such as methyl, ethyl, propyl, butyl, pentyl, hexyl, cyclohexyl and heptyl, aryl groups such as phenyl, tolyl, xylyl and naphthyl, aralkyl groups such as benzyl and phenethyl, and halo-alkyl groups such as chloromethyl, 3-chloropropyl and 3,3,3-trifluoropropyl. Of these, methyl and phenyl are most preferred.

The content of alkenyl groups in component (A) is preferably 0.001 to 10 mol %, more preferably 0.001 to 5 mol %, based on all the silicon atom-bonded organic groups (or unsubstituted or substituted monovalent hydrocarbon groups).

Component (A) has a molecular structure which may be, for example, linear, linear with some branching, cyclic, or branched. Preferred is a linear diorganopolysiloxane in which the backbone is essentially composed of repeating diorganosiloxane units and both ends of the molecular chain are capped with triorganosiloxy groups wherein the “organo” groups may include alkenyl groups as well.

It is desirable for component (A) to have a viscosity at 25° C. of at least 100 mPa·s because the resulting composition is easy to handle and work and the resulting silicone rubber has good physical properties. Oily organopolysiloxanes (e.g., a viscosity in a range of about 100 to 1,000,000 mPa·s, and preferably about 400 to 100,000 mPa·s) and gum-like organopolysiloxanes are included. It is noted that the viscosity is measured by a rotational viscometer at 25° C.

Illustrative examples of organopolysiloxanes (A) include trimethylsiloxy end-capped dimethylsiloxane-methylvinylsiloxane copolymers, trimethylsiloxy end-capped methylvinylpolysiloxanes, trimethylsiloxy end-capped dimethylsiloxane-methylvinylsiloxane-methylphenylsiloxane copolymers, dimethylvinylsiloxy end-capped dimethylpolysiloxanes, dimethylvinylsiloxy end-capped methylvinylpolysiloxanes, dimethylvinylsiloxy end-capped dimethylsiloxane-methylvinylsiloxane copolymers, dimethylvinylsiloxy end-capped dimethylsiloxane-methylvinylsiloxane-methylphenylsiloxane copolymers, trivinylsiloxy end-capped dimethylpolysiloxanes, and mixtures comprising at least two of the foregoing organopolysiloxanes.

Throughout the specification, the term “end-capped” used in connection with siloxanes means that a siloxane is capped with a specified group at each end of its molecular chain.

The organopolysiloxane resin (B) is added, if necessary, for improving the mechanical strength of silicone rubber coating film. It is an organopolysiloxane resin of three-dimensional network structure essentially containing trifunctional siloxane units (or organosilsesquioxane units) and/or SiO_{4/2} units.

The siloxane units of which the organopolysiloxane resin is composed include a combination of R₃SiO_{1/2} units, RSiO_{3/2} units and SiO_{4/2} units, a combination of R₃SiO_{1/2} units, R₂SiO_{2/2} units and RSiO_{3/2} units, a combination of R₃SiO_{1/2} units and RSiO_{4/2} units, a combination of R₃SiO_{1/2} units and RSiO_{3/2} units, and a combination of R₃SiO_{1/2} units, R₂SiO_{2/2} units and SiO_{4/2} units. Polyorganosilsesquioxane resins consisting of RSiO_{3/2} units are also included. Herein, R stands for substituted or unsubstituted monovalent hydrocarbon groups of about 1 to 10 carbon atoms, preferably about 1 to 8 carbon atoms, for example, alkyl groups such as methyl, ethyl, propyl, butyl, pentyl, hexyl, and cyclohexyl; aryl groups such as phenyl, tolyl, and xylyl; alkenyl groups such as vinyl, allyl and butenyl; and halo-alkyl groups such as chloromethyl, 3-chloropropyl and 3,3,3-trifluoropropyl. At each occurrence, R may be the same or different.

The amount of the organopolysiloxane resin added is up to 5 parts by weight (i.e., 0 to 5 parts by weight) per 100 parts by weight of component (A). Beyond the range, more amounts may adversely affect the coating stability during high-speed application, making it difficult to form a uniform coating, particularly in a thin-film coating weight range equal to or less than 30 g/m². The preferred amount of the organopolysiloxane resin added is 0.1 to 5 parts by weight, more preferably 0.5 to 4 parts by weight.

Component (C) is finely divided silica which may be any known silica used as a reinforcing filler for silicone rubber. To this end, silica should have a specific surface area of at least 50 m²/g, and preferably 100 to 400 m²/g, as measured by the BET method. Silica with a surface area of less than 50 m²/g fails to achieve the desired silicone rubber reinforcement.

Exemplary silicas include fumed silica (also referred to as dry silica) and precipitated silica (also referred to as wet silica), with the fumed silica being preferred. The surface of silica may be subjected to hydrophobic treatment with suitable agents such as organopolysiloxanes, organopolysilazanes, chlorosilanes and alkoxysilanes. Any one or combinations of two or more of the foregoing silicas may be used.

An appropriate amount of finely divided silica (C) added is 0.1 to 50 parts by weight per 100 parts by weight of the organopolysiloxane (A). Less than 0.1 pbw of silica is too small to provide reinforcement whereas more than 50 pbw of silica makes the composition less workable and detracts from physical properties of the silicone rubber. The preferred amount of silica is 0.5 to 30 parts, more preferably 1 to 30 parts, and most preferably 5 to 25 parts by weight.

Component (D) is an organohydrogenpolysiloxane containing at least two, preferably at least three silicon atom-bonded hydrogen atoms (i.e., SiH groups) on the molecule. It may have a linear, branched or cyclic structure or be a resinous one of three-dimensional network structure. Typical of the organohydrogenpolysiloxane are those having the average compositional formula (I).
HₐR¹_{b}SiO_{(4-a-b)/2} (I
Herein R¹ is each independently a substituted or unsubstituted monovalent hydrocarbon group free of aliphatic unsaturation. The subscripts “a” and “b” are numbers satisfying 0<a<2, 0.8≦b≦2 and 0.8<a+b≦3, preferably 0.01≦a≦1.1, 0.9≦b≦2 and 1.0≦a+b≦3, and more preferably 0.05≦a≦1, 1.5≦b≦2 and 1.8≦a+b≦2.7.

In formula (I), the substituted or unsubstituted monovalent hydrocarbon groups free of aliphatic unsaturation represented by R¹ include those of 1 to 10 carbon atoms, preferably 1 to 7 carbon atoms, for example, alkyl groups such as methyl, ethyl, propyl, butyl, pentyl, hexyl, cyclohexyl and heptyl, aryl groups such as phenyl, tolyl, xylyl and naphthyl, aralkyl groups such as benzyl and phenethyl, and haloalkyl groups such as chloromethyl, 3-chloropropyl and 3,3,3-trifluoropropyl. Of these, lower alkyl groups of 1 to 3 carbon atoms, typically methyl, phenyl and 3,3,3-trifluoropropyl are preferred.

In the organohydrogenpolysiloxane, hydrogen atoms may be bonded to any silicon atoms at ends or intermediate positions of the molecular chain or both. The organohydrogenpolysiloxane contains per molecule at least two hydrogen atoms (specifically 2 to about 300 hydrogen atoms), preferably at least three hydrogen atoms (specifically 3 to about 200 hydrogen atoms), and more preferably 3 to about 100 hydrogen atoms. The number of silicon atoms per molecule is typically 2 to about 300, preferably 3 to about 200, and more preferably 4 to about 100.

Examples of the organohydrogenpolysiloxane include siloxane oligomers such as tris(dimethylhydrogensiloxy)methylsilane, tris(dimethylhydrogensiloxy)phenylsilane, 1,1,3,3-tetramethyldisiloxane, 1,3,5,7-tetramethyltetracyclosiloxane, and 1,3,5,7,8-pentamethylpentacyclosiloxane; trimethylsiloxy end-capped methylhydrogenpolysiloxane, trimethylsiloxy end-capped dimethylsiloxane-methylhydrogensiloxane copolymers, silanol end-capped methylhydrogenpolysiloxane, silanol end-capped dimethylsiloxane-methylhydrogensiloxane copolymers, dimethylhydrogensiloxy end-capped dimethylpolysiloxane, dimethylhydrogensiloxy end-capped methylhydrogenpolysiloxane, dimethylhydrogensiloxy end-capped dimethylsiloxane-methylhydrogensiloxane copolymers; and silicone resins comprising R²₂(H)SiO_{1/2} units and SiO_{4/2} units and optionally, R²₃SiO_{1/2} units, R²₂SiO_{2/2} units, R²(H)SiO_{2/2} units, (H)SiO_{3/2} units or R²SiO_{3/2} units wherein R² is a substituted or unsubstituted monovalent hydrocarbon group as exemplified above for R¹.

The organohydrogenpolysiloxane is preferably used in such amounts that 0.5 to 20 moles, more preferably 0.8 to 5 moles of silicon atom-bonded hydrogen atoms (i.e., SiH groups) in the organohydrogenpolysiloxane are present per mole of total silicon atom-bonded alkenyl groups in components (A) and (B). With too less amounts of SiH groups, the cured composition (or silicone rubber coating layer) has insufficient strength. With too much amounts of SiH groups, the cured composition becomes very poor in heat resistance and strength.

Any addition reaction catalysts may be used as component (E) as long as they are effective for promoting the addition reaction between alkenyl groups in components (A) and (B) and SiH groups in component (D). Exemplary catalysts are platinum group metals and compounds thereof including platinum, palladium and rhodium; chloroplatinic acid, alcohol-modified chloroplatinic acid, coordination compounds of chloroplatinic acid with olefins, vinylsiloxanes or acetylene compounds; tetrakis(triphenylphosphine)palladium, and chlorotris(triphenylphosphine)rhodium. Inter alia, the platinum compounds are preferred.

Component (E) is used in catalytic amounts, preferably such as to give 1 to 500 ppm, more preferably 10 to 100 ppm of catalytic metal element based on the weight of components (A), (B) and (D) combined. If the amount is less than 1 ppm, addition reaction may slow down or no cure may occur. If the addition amount exceeds 500 ppm, the cured polysiloxane composition may have poor heat resistance.

The organosilicon compound (F) is included in the composition for improving the adhesion of the composition to base fabrics (synthetic fiber woven fabrics or non-woven fabrics) for airbags. From the standpoint of imparting self-adhesion nature to the addition reaction type silicone rubber composition, silicon compounds having functional groups for imparting tack are used.

Examples of the organosilicon compounds include organosilanes, straight or cyclic siloxane oligomers of 3 to 50 silicon atoms, preferably 5 to 20 silicon atoms, (alkoxy)silyl-modified triallylisocyanurates and siloxane derivatives thereof, each of which has functional groups selected from among alkenyl groups bonded directly to silicon atoms, such as vinyl and allyl; epoxy groups bonded to silicon atoms via carbon atoms, such as γ-glycidoxypropyl and β-(3,4-epoxycyclohexyl)ethyl; (meth)acryloxy groups, such as γ-acryloxypropyl and γ-methacryloxypropyl; alkoxysilyl groups bonded to silicon atoms via alkylene groups which may contain one or two ester, urethane or ether structures, such as trimethoxysilyl, triethoxysilyl and methyldimethoxysilyl; and SiH groups. Those compounds having functional groups of at least two types per molecule are preferred. Illustrative, non-limiting examples of the organosilicon compounds having such functional groups are given below.

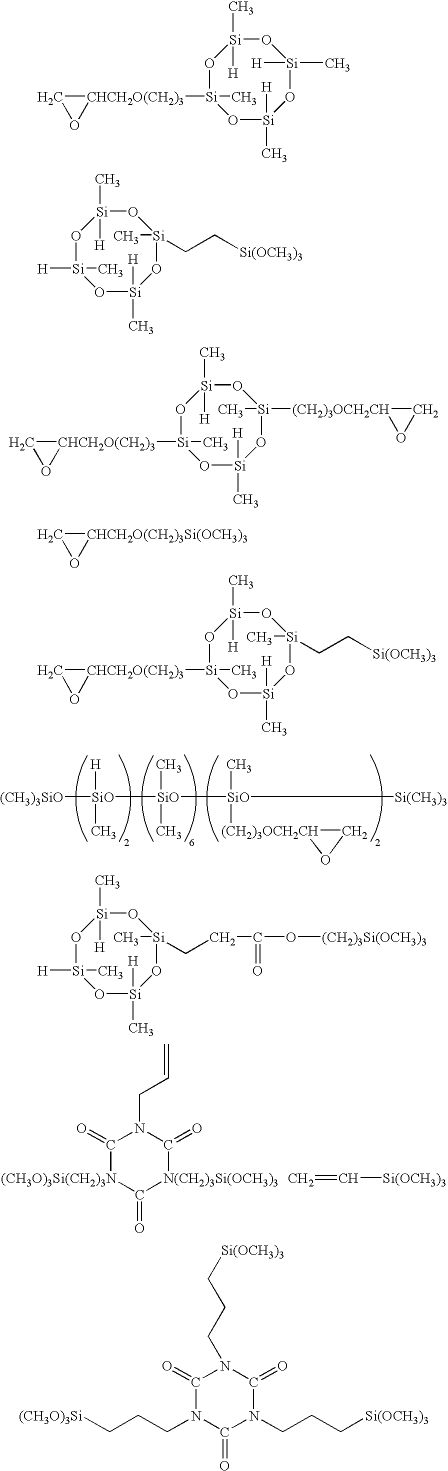

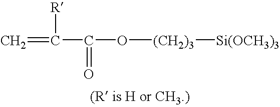

The amount of component (F) compounded is 0.1 to 10 parts by weight per 100 parts by weight of component (A), with the preferred amount being 0.5 to 5 parts by weight. Less than 0.1 pbw of component (F) results in the cured composition having insufficient bond strength. More than 10 pbw of component (F) increases the cost, with the composition becoming uneconomical.

Component (G) is an organotitanium compound, an organozirconium compound or a mixture thereof. It is requisite for improving adhesion, especially after hot humid holding. Illustrative, non-limiting examples of the organotitanium compound include organic titanic acid esters such as tetraisopropyl titanate, tetrabutyl titanate, and tetraoctyl titanate; and titanium chelate compounds such as diisopropoxybis(acetylacetonato)titanium and diisopropoxybis (ethyl acetoacetate) titanium. Illustrative, non-limiting examples of the organozirconium compound include tetrapropoxyzirconium, tetrabutoxyzirconium, zirconium tetraacetylacetonate, zirconium tributoxyacetylacetonate, and zirconium tributoxystearate.

The amount of component (G) compounded is 0.01 to 10 parts by weight per 100 parts by weight of component (A), with an amount of 0.1 to 5 pbw being preferred, and 0.5 to 3 pbw being more preferred. More than 10 pbw of component (G) has negative impact on the storage stability of the composition. Less than 0.01 pbw of component (G) results in poor bond strength after hot humid holding.

In addition to the above-described components (A) to (G), the inventive composition may further contain various additives. For example, reinforcing inorganic fillers such as fumed titanium dioxide, and non-reinforcing inorganic fillers such as crystalline silica, calcium silicate, titanium dioxide, ferric oxide and carbon black may be added. The amount of such inorganic filler used is usually 0 to 200 parts by weight per 100 parts by weight of all the components combined (exclusive of the inorganic filler).

To improve the dispersion of components (A) and (C), low-molecular weight organosilicon compounds, known as wetters, such as diorganopolysiloxane having hydroxyl groups at ends, diphenylsilane diol, hexaorganopolysiloxane, and organoalkoxysilane may be compounded in the composition.

There may be compounded heat resistance improvers including metal oxides such as iron oxide, cerium oxide, zinc oxide, and titanium oxide, cerium silanolate and cerium fatty acid salts. Also useful are flame retardants and pigments including platinum compounds such as platinic chloride, chloroplatinic acid, complexes of chloroplatinic acid hexahydrate with olefins or divinyldimethylpolysiloxane, alcohol solutions of chloroplatinic acid hexahydrate, titanium oxide, and nitrogen-containing organic compounds.

For controlling the platinum group catalyzed reaction, reaction regulators as typified by vinylmethylcyclopolysiloxanes and acetylene alcohols may be added.

Further, the composition may be diluted with an organic solvent for viscosity adjustment. However, in a preferred embodiment, the use of an organic solvent is avoided for the reason that it would increase the load or burden to the operator or the environment during application.

The silicone rubber coating composition of the invention is generally prepared by intimately mixing components (A) and (C) or components (A), (B) and (C) on a rubber kneading machine such as a twin-roll mill, Banbury mixer, dough mixer or kneader, adding components (D), (E), (F) and (G) thereto, and continuing mixing.

The synthetic fiber base fabric of which the airbag is made may be selected from woven or non-woven fabrics of polyamide fibers such as nylon 6, nylon 66 and nylon 46; aramide fibers such as copolymers of p-phenylene terephthalamide and all aromatic ethers; polyester fibers such as polyalkylene terephthalate; vinylon fibers, rayon fibers, polyolefin fibers, polyether imide fibers and carbon fibers. Of these base fabrics, nylon 66 fiber woven fabric is most preferred.

The silicone rubber coating composition is coated onto a synthetic fiber base fabric and heat cured in a hot air dryer, obtaining a silicone rubber-coated fabric for airbags. When the composition of the invention is applied to a synthetic fiber base fabric, a uniform silicone rubber coating film can be formed without variations in coating weight or thickness. Any customary technique may be used in applying the inventive silicone rubber coating composition to the airbag base fabric.

The coating weight of the silicone rubber coating composition varies with the structure and application of airbags. In general, the airbags include the hollow weave structure in which silicone rubber is coated onto opposite surfaces of an airbag of hollow weave structure and the plain weave structure manufactured by mating a pair of plain weave fabric pieces coated or lined with silicone rubber on the inner surface, and joining them along the periphery with an adhesive. In the case of hollow weave structure airbags, the coating composition is coated in an amount of 30 to 150 g/m², and especially in the case of side curtain airbags requiring air tightness, the coating weight is at least 60 g/m². In the case of plain weave structure airbags, the coating composition is coated in an amount equal to or less than 60 g/m². For the purposes of profile reduction upon folding, weight reduction, and cost reduction, a coating weight equal to or less than 40 g/m² is often used. When applied as a coating to both the former airbags and the latter airbags, the silicone rubber coating composition of the invention is equally effective and develops improved adhesiveness. In particular, the silicone rubber coating composition of the invention is effective as a coating to the latter airbags using plain weave fabric because a uniform thin film can be consistently formed even at a coating weight equal to or less than 30 g/m².

The composition is then cured in a known way under ordinary conditions, typically at a temperature of 80 to 250° C. for 30 seconds to 10 minutes.

### EXAMPLE

Examples and Comparative Examples are given below for illustrating the present invention although the invention is not limited thereto. All parts are by weight. The viscosity is measured by a Brookfield rotational viscometer at 25° C. The amount (in ppm) of platinum catalyst is an amount of platinum metal based on the total weight of components (A), (B) and (D).

### Preparation Example 1

Base Compound A was prepared by kneading 85 parts of a dimethylvinylsiloxy end-capped dimethylpolysiloxane having a viscosity of 1 Pa·s, 30 parts of fumed silica having a BET specific surface area of 300 m²/g (Aerosil 300 by Nippon Aerosil Co., Ltd.), and 5 parts of hexamethyldisilazane as a dispersant on a kneader, heat treating the mixture at 150° C. for 3 hours, and further compounding 60 parts of the dimethylvinylsiloxy end-capped dimethylpolysiloxane having a viscosity of 1 Pa·s.

### Example 1

To 100 parts of Base Compound A were added 30 ppm (as platinum metal) of a chloroplatinic acid-divinyltetramethyl-disiloxane complex as a curing agent, 0.05 part of 1-ethynyl cyclohexan-1-ol, 10 parts of a trimethylsiloxy end-capped dimethylsiloxane-methylhydrogensiloxane copolymer (Si—H 0.007 mol/g), 1.0 part of 3-glycidoxypropyltrimethoxysilane, and 1 part of tetraoctyl titanate. The ingredients were kneaded on a spiral mixer, yielding a silicone rubber coating composition No. 1 (Example 1).

The silicone rubber coating composition No. 1 was uniformly applied onto nylon 66 fiber woven fabric (420 denier) so as to give a solid coating weight of 25 g/m², and vulcanized at 100° C. for 45 seconds and then at 180° C. for 45 seconds whereby the coating was cured to the fabric.

The coated fabric was examined for coatability by observing whether or not the coating was uniform at the selected coating weight of 25 g/m². The coated fabric was also examined for adhesion by a Scott flexing test (2 kgf, 500 cycles). Additionally, the coated fabric was held under hot humid conditions: 80° C. and a humidity of 95% for 240 hours before it was examined for adhesion again by a Scott flexing test (2 kgf, 500 cycles). The coated fabric was measured for longitudinal tear strength according to JIS L-1096. The results are shown in Table 1.

### Example 2

To 100 parts of Base Compound A were added 4 parts of an organopolysiloxane resin consisting of 39.5 mol % (CH₃)₃SiO_{1/2} units, 6.5 mol % (CH₃)₂(CH₂□CH)SiO_{1/2} units and 54 mol % SiO₂ units, 30 ppm (as platinum metal) of a chloroplatinic acid-divinyltetramethyldisiloxane complex as a curing agent, 0.05 part of 1-ethynyl cyclohexan-1-ol, 10 parts of a trimethylsiloxy end-capped dimethylsiloxane-methylhydrogensiloxane copolymer (Si—H 0.007 mol/g), 1.0 part of 3-glycidoxypropyltrimethoxysilane, and 1 part of tetraoctyl titanate. There was obtained a silicone rubber coating composition No. 2 (Example 2).

The same tests as in Example 1 were performed, with the results shown in Table 1.

### Example 3

To 100 parts of Base Compound A were added 4 parts of an organopolysiloxane resin consisting of 39.5 mol % (CH₃)₃SiO_{1/2} units, 6.5 mol % (CH₃)₂(CH₂═CH)SiO_{1/2} units and 54 mol % SiO₂ units, 30 ppm (as platinum metal) of a chloroplatinic acid-divinyltetramethyldisiloxane complex as a curing agent, 0.05 part of 1-ethynyl cyclohexan-1-ol, 10 parts of a trimethylsiloxy end-capped dimethylsiloxane-methylhydrogensiloxane copolymer (Si—H 0.007 mol/g), 1.0 part of 3-glycidoxypropyltrimethoxysilane, and 1 part of tetrabutoxyzirconium. There was obtained a silicone rubber coating composition No. 3 (Example 3).

The same tests as in Example 1 were performed, with the results shown in Table 1.

### Comparative Example 1

A silicone rubber coating composition No. 4 (Comparative Example 1) was obtained as in Example 1 aside from omitting tetraoctyl titanate. The same tests as in Example 1 were performed, with the results shown in Table 1.

### Comparative Example 2

A silicone rubber coating composition No. 5 (Comparative Example 2) was obtained as in Example 1 aside from omitting 3-glycidoxypropyltrimethoxysilane. The same tests as in Example 1 were performed, with the results shown in Table 1.

### Comparative Example 3

A silicone rubber coating composition No. 6 (Comparative Example 3) was obtained as in Example 2 except that 10 parts of the organopolysiloxane resin consisting of 39.5 mol % (CH₃)₃SiO_{1/2} units, 6.5 mol % (CH₃)₂(CH₂═CH)SiO_{1/2} units and 54 mol % SiO₂ units was added to 100 parts of Base Compound A. The same tests as in Example 1 were performed, with the results shown in Table 1.

TABLE 1

| | | Example | | | Comparative Example | | |
|---|---|---|---|---|---|---|---|
| | | 1 | 2 | 3 | 1 | 2 | 3 |
| Composition | | No. 1 | No. 2 | No. 3 | No. 4 | No. 5 | No. 6 |
| Coatability | | Pass | Pass | Pass | Pass | Pass | Rejected |
| Scott | Before hot | Pass | Pass | Pass | Pass | Rejected | Pass |
| flexing | humid holding | | | | | | |
| test | After hot | Pass | Pass | Pass | Rejected | Rejected | Pass |
| | humid holding | | | | | | |

| | | | | | | |
|---|---|---|---|---|---|---|
| Tear strength of | 260 | 320 | 310 | 270 | 150 | 335 |
| coated fabric (N) | | | | | | |

Evaluation of Coatability

The coating weight was measured at opposite edges and the center of the coated surface. The difference between maximum and minimum coating weights was computed.
Pass: The sample passed the test when the difference was within 10% of the minimum.
Rejected: The sample was rejected when the difference exceeded 10% of the minimum.
   Scott Flexing Test
Pass: The sample passed the test when the coating did not peel from the base fabric.
Rejected: The sample was rejected when the coating peeled from the base fabric.

Japanese Patent Application No. 2005-174566 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A silicone rubber coating composition for airbags, comprising
(A) 100 parts by weight of a diorganopolysiloxane containing at least two alkenyl groups on the molecule,
(B) 0 to 5 parts by weight of an organopolysiloxane resin,
(C) 0.1 to 50 parts by weight of finely divided silica having a specific surface area of at least 50 m²/g,
(D) an organohydrogenpolysiloxane containing at least two silicon-bonded hydrogen atoms on the molecule, in such an amount that 0.5 to 20 moles of silicon-bonded hydrogen atoms are available per mole of total silicon-bonded alkenyl groups in components (A) and (B),
(E) a catalytic amount of an addition reaction catalyst,
(F) 0.1 to 10 parts by weight of an organosilicon compound containing a tackifying functional group, and
(G) 0.01 to 10 parts by weight of an organotitanium compound and/or an organozirconium compound.

2. The composition of claim 1 which is free of an organic solvent.

3. An airbag comprising a base fabric and a cured film formed thereon from the silicone rubber coating composition of claim 1.
